(19) United States
(12) Patent Application Publication
(10) Pub. No.: US 2008/0263681 A1
(43) Pub. Date: Oct. 23, 2008

(54) System and Method for Transferring Media Rights Under Predetermined Conditions

(75) Inventors: Jacobus Dooms, Eindhoven (NL); Jeroen Franciscus Hubertus Van Agt, Eindhoven (NL); Bernardus P. H. C. Van Gompel, Eersel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,733

(22) PCT Filed: Feb. 20, 2006
(86) PCT No.: PCT/IB2006/050545

§ 371 Date: Aug. 21, 2007

Related U.S. Application Data
(60) Provisional application No. 60/655,080, filed on Feb. 22, 2005.

(51) Int. Cl. G06F 21/24; G06F 15/16; G06Q 30/00

(52) U.S. Cl. 726/33; 726/26; 709/203; 705/26

(57) ABSTRACT

A method for distributing media rights includes obtaining (102) media rights for distribution by a media rights holder and transmitting (103) media content to one or more conditional users from the media rights holder. Upon termination of a condition related to a status of the media rights holder, the media rights are revoked (112) for the one or more conditional users.

This disclosure relates to media transfer, and more particularly to systems and methods for users with media rights to transfer these media rights while predetermined conditions exist.

Media companies are faced with many issues in the distribution of media content. While it is important to protect the content rights, e.g., copyrights, marketing and proper distribution are necessary to generate revenue from these rights. Some of the techniques used to market content included demonstration copies of a title. For example, a computer game may have a watered down version, which may be played by a potential purchaser over the Internet, a portion of a song may be played by a user or a limited version of a software title may be provided to a user for a limited time.

These techniques often fall short of customer expectations due at least in part to the customer not being exposed to the full version of the content or all the capabilities that would be provided by the full version of the content. Therefore, it would be advantageous to have a system and method, which permits an individual to experience a full version of the media content provided by a title but still provides ample protection for media rights.

A method for distributing media rights includes obtaining media rights for distribution by a media rights holder and transmitting media content to one or more conditional users from the media rights holder. Upon termination of a condition related to a status of the media rights holder, the media rights are revoked for the one or more conditional users.

A system for distributing media rights includes a first device configured to communicate with other devices and transmit media rights to other devices for conditional use. At least one module monitors a state upon which a condition of use is based. The first device permits conditional usage of media content and revokes the media rights when a condition of use fails. The state/conditional monitored may include a periodically updated license provided to a conditional user, and the condition fails when the periodically updated license is not sent to the conditional user

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

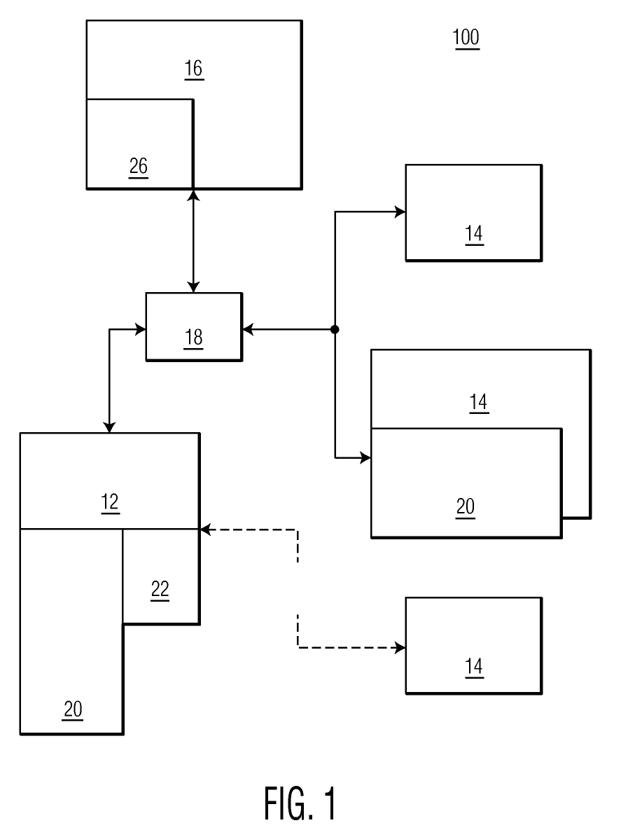

FIG. 1 is a block diagram showing a system for distributing and revoking media rights based on one or more conditions in accordance with an illustrative embodiment;

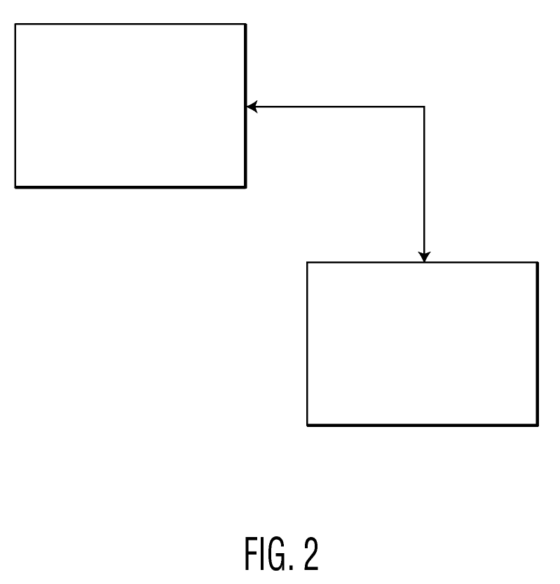

FIG. 2 is a block diagram showing a system where media rights for different titles are simultaneously shared between two entities in accordance with an illustrative embodiment; and

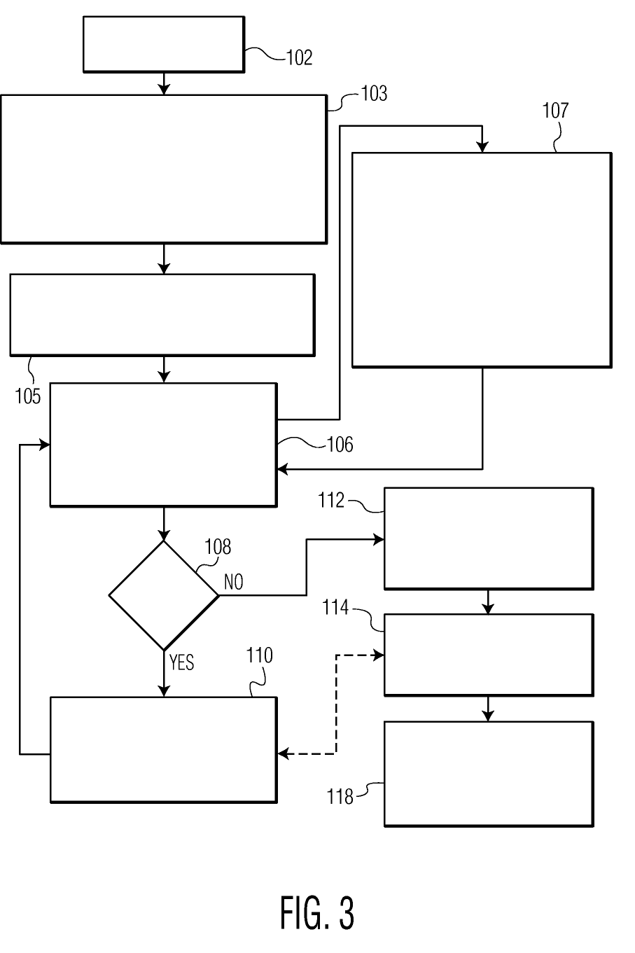

FIG. 3 is a block/flow diagram showing a system/method for distributing and revoking media rights based on one or more conditions in accordance with an illustrative embodiment.

The present disclosure provides a system and method for enabling individuals to distribute media content or titles to others under given conditions. In one example, a user with media rights for a given title can distribute the title to others under the condition that the user with media rights must be on-line during the use by the others designated by the user. In an alternative embodiment, the user would have to be within a certain distance of the other designated by the user. These and other embodiments will be described in greater detail below. The present disclosure will describe a plurality of different illustrative embodiments to demonstrate ways in which the present disclosure may be implemented. These embodiments are illustrative only and should not be construed as limiting.

To more efficiently describe aspects of the embodiments herein, the following are loosely defined in accordance with this disclosure. An individual or entity that obtains media rights for distribution to other will be referred to as a media rights holder, or rights holder or simply holder. An individual or entity that receives distributed rights or conditional media rights from the rights holder will be referred to a rights receiver or conditional holder or a conditional user.

It should be understood that the elements shown in the FIGS. may be implemented in various forms of hardware, software or combinations thereof. Preferably, these elements are implemented in a combination of hardware and software, which may employ one or more appropriately programmed general-purpose digital computers having a processor, display memory and input/output interfaces. The elements depicted in the FIGS. may be implemented in various combinations of hardware and software and provide functions which may be combined in a single element or multiple elements. In addition, the elements shown may be distributed over a network or networks or may be located at a single location.

Referring now to the drawings in which like numerals represent the same or similar elements and initially to FIG. 1, an illustrative system 100 is shown, to demonstrate features and aspects of embodiments in accordance with the present disclosure. System 100 may be implemented in a wired or wireless network 18. Network 18 may include the Internet, a local area network, a designated network, such as a home network, a telephone or a cable network, a wireless network, a satellite network, etc. Network 18 provides for device interaction and communication via a given protocol. The selection of network therefore is not to be construed as limiting.

System 100 includes a media rights holder device 12, which may include a predesignated module or any device that may become a media rights holder 12. Media rights holder 12 communicates either directly (without network 18) or through network 18 with conditional holders 14. Holder 12 and conditional holders 14 may include the same type of device or different types of devices. Holder 12 and conditional holders 14 may include, for example, computers, kiosk, telephones, set-top boxes, personal digital assistant (PDA) capable of outside communication or similar devices. In one embodiment, media rights are wirelessly distributed from a kiosk in a common area to promote a media title, for example.

In one embodiment, a media rights provider 16 permits media rights holder 12 the right to use media content (e.g., a title). Media rights provider 16 may include an artist, software company, movie/video provider etc. or an authorized agent with the ability to grant media rights. Media rights provider 16 may include an Internet service provider (ISP) (e.g., including a server), which is authorized to download, music titles, software titles, movies/videos, literature, or any other media content. In another embodiment, media rights holder 12 may be the owner of the media rights.

Once media rights holder 12 receives the content and the rights to distribute that content, media rights holder 12 can send the media content to one or more conditional holders 14. The conditional holders 14 will then be permitted to use the content as long as a predefined condition exists. In one example, the predefined condition includes that the media rights holder needs to be on-line during the conditional holder's use of the content. Other examples include, the media rights holder's equipment needs to be on to maintain the conditional user's rights. In another example, signal strength between the media rights holder and the conditional user may be determinative of whether the media rights are revoked. If, e.g., the signal strength falls below a threshold value, the rights are terminated/revoked.

For example, media rights holder 12 has an authorized copy of a computer game. Media rights holder 12 sends the game to conditional holder via instant messaging, email, file transfer or download. A status module 20 monitors the status of media rights holder's device to ensure that the media rights holder remains connected to the network or to the conditional holders device 14. Status module 20 may be located on media rights holder's device 12 in the form of hardware or software. In one example, when the media rights holder 12 logs off or shuts down, a signal is sent to current conditional users devices 14 revoking or terminating their conditional right, which were originated through media rights holder 12.

If the connection is broken by the media rights holder, the conditional holder 14, or the media rights holder signing off, the conditional media rights are withdrawn and the conditional holder 14 may no longer use the media content, which was conditionally sent to conditional holder 14. This may be performed by the conditional holder 14 monitoring the activities of the media rights holder 12. This may include a program or application running on the conditional holder's device 14 (which may be sent as part of the content to the conditional holder), which verifies the condition or status of the media rights holder's device 12.

In a particularly useful embodiment, licenses, which expire within a very short time frame (for example every minute or few minutes) may be employed. The conditional holder 14 receives a new license every period (e.g., one minute) as long as conditional user 14 has a connection with the rights holder 12. If the connection breaks (for whatever reason), the conditional user 14 does not get a license update. After the conditional user's current license has expired (for example, after 1 minute), the user 14 is unable to use the protected media anymore.

Status module 20 may be located at the media rights holder device 12 or the conditional holder's device 14 or distributed between both. Status module 20 may be implemented in software and check whether the media rights holder 12 remains on-line, connected to a network, within a particular geographical area (e.g., using a wireless power signal or global positioning system to determine location). Status module 20 monitors activity of holder 12 and sends updates to users 14. At the user's location, users 14 listen for updates from module 20. This updates may includes the status of the holder 12 or a new temporary license. When no updates or no licenses are received after a given period of time elapses, media rights are revoked. Time for sending out updates may be monitored by system clocks or a designated timing device 22.

In another embodiment, the condition includes an elapsed time or time of usage. A timer 22 maybe implemented in software and be located or executed on the media rights holder's device 12 or on the conditional holder's device 14. The conditional holder's device 14 may include a display of the elapsed time, time remaining or time of usage as a reminder or indicator that the conditional rights will be expiring.

It is to be understood that the conditional holder 14 can run or play the media content independently from the media rights holder 12 and independent from other conditional holders 14. For example, media rights holder 12 downloads a song from media rights provider 16. Holder 12 enjoys the song enough to want to send the song to several of his/her friends (conditional holders 14). Holder 12 sends the songs via instant message, email, file transfer or permits conditional holders 14 access to media rights holder's 12 file storage space (memory). Conditional holders 14 may listen to the song as long as the condition holds. For example, the condition may be that the media rights holder 12 needs to be on-line, connected directly to conditional holder 14 (e.g., by telephone, or through wireless communication), or satisfy another condition or combination of conditions. Other conditions may include elapsed time, or limit the conditional user to a number of times the song can be played. The conditional holder 14 can play the song independently of the activity of the media rights holder 12, as long as the condition or conditions of the usage are satisfied.

In another embodiment, media rights holder 12 broadcasts media rights to conditional holders 14. These rights are only valid when the media rights holder 12 is within range of the conditional holders 14. This permits holder 12 to distribute the media content to conditional holders 14 while the media rights holder 12 is within range. When the holder goes out of range, the conditional holders 14 lose their rights and access to the media content.

Any device capable of supporting media content and communicating the media content to others may act in the role of media rights holder 12.

Referring to FIG. 2, two devices 30 and 32 are illustratively shown. Devices 30 and 32 may include one or more of cellular telephones, computers, PDA's, set-top boxes, etc. or combinations thereof. While FIG. 2 shows two devices, the system may include more devices with complex media rights holder/conditional holder relationships. Device 30 is a media rights holder for title A, which may be any type of media content, say, e.g., a song title. Device 32 is a media rights holder for title B, which may be any type of media content, say, e.g., a game title. Device 30 permits device 32 to have conditional media rights to title A. This is reciprocated by device 32 permitting device 30 to have conditional rights to title B. This may be performed simultaneously or sequentially.

It is to be understood that the playing or usage of the media based on the conditional holder's status may be performed independently from the activities of the respective media rights holder. For example, device 30 can play title B while device 32 plays title A, or alternately devices 30 and 32 can play title A at the same time or at different times and similarly with title B.

Returning to FIG. 1, since media rights providers desire to distribute and sell their media rights, during or after conditional holder's 14 usage of the media content provided through media rights holder 12, a purchase module 26 may generate a screen to offer the media content or rights thereof to the conditional holder 14. For example, during a session, holder 12 forwards a title to conditional holder 14. During conditional holder's use of the title a screen is generated to offer the title for sale by conditional holder 14. Alternately, this offer can be provided after the media rights have been revoked (e.g., after the media rights holder 12 is off-line, etc.).

The management of the purchase may be provided by the media rights holder 12 or the media rights provider 16, since communications may be linked to either entity. After a conditional user 14 is established, provider 16 may contact that user 14 directly to solicit a purchase. Purchase module 26 generates an interface, e.g., a web page, menu, pop-up etc., which prompts the conditional user 14 to enter financial and/or personal data to carry out the purchase, e.g., credit card information, expiration date, name, email address, etc. Upon purchase of the media rights content may be sent to the conditional holder 14.

It should be noted that system 100, preferably pushes content out from the holder 12 rather than responding to a request from a user. This helps to ensure that media rights conditionally granted are legally in possession of the holder 12.

Referring to FIG. 3, a method for distributing media rights is illustratively shown. In block 102, a media rights holder obtains media rights for distribution. This may include obtaining authorized media rights by downloading media content from a network, purchasing media content through retail stores or online from an Internet service provider, website, etc. (e.g., media rights provider). In block 103, media content is transmitted to one or more conditional users from the media rights holder. This may include, e.g., broadcasting the media content to conditional users in a given area, transferring the media content to specifically identified conditional users, which may include, e.g., transferring the rights/content by email, file transfer and/or instant messaging. Block 103 may include specifically identifying conditional users (e.g., email) or sending a general broadcast to users in a given area, e.g., an area surrounding a transmitting kiosk in a public place such as a mall or the like.

In block 105, the one or more conditional users conditionally use the media content provided by the media rights holder. This is performed independently of the usage of the same or different media content by the media rights holder. For example, the conditional usage of the media rights by the conditional user(s) is preferably independent of the media rights holders usage of the same media content. In one embodiment, the media rights holder sends the content to conditionally users, but the content is not usable without media rights. While the conditional user may store the content the content may not be used if the media rights are revoked. Revoking of rights may be performed in a plurality of ways, and may include providing a key, access code, encryption code or other security feature that may expire over time or upon occurrence of a termination event based on, e.g., the status of the media rights holder's equipment.

In block 106, the status of one or more conditions is monitored. Upon termination of a condition (condition not valid), preferably related to a status of the media rights holder, the media rights are revoked for the one or more conditional users. Part of the monitoring step 106 includes determining a condition status based upon an activity performed by the media rights holder. The activity is preferably related to equipment status of the media rights holder. For example, in block 107, failure of the one or more conditions may include when a media rights holder goes off-line, when the media rights holder turns off a device used for transmitting, an elapsed time passes a set threshold, the media rights holder (or conditional user) is out of range, etc.

In block 108, the validity of the condition(s) is/are checked. If the condition is valid, the one or more conditional users may continue use of the media content, in block 110, and if the condition is not valid, media rights are revoked for using of the media content by the one or more conditional users, in block 112. The condition status may include an operational state of a device employed by the media rights holder to perform transmission. The condition status may include a power state for a device of the media rights holder, and the condition is valid while the device is on. The condition status may include signal power, and the condition is valid while the conditional users receive a usable signal from the media rights holder.

In block 114, the media rights holder or the media rights provider may offer the media content for sale to the conditional users. This offer may be made at any time during the or after the session. Since the content may be independently sent or sent together, the revocation of rights may be performed even though the conditional user may have the media content stored on his/her device already (e.g., the rights and content may be bundled separately). In this way, when an offer for sale is made and accepted by the conditional user, the content becomes freely accessible upon payment of the appropriate fee. This may be provided to the user be sending a different security code or key such that once entered the content is freely accessible by the conditional user. Once the full rights have been purchased or leased by the conditional user, the conditional user may now become a media rights holder, in block 118, for the content purchased and transmit that content to conditional users as set forth above.

The methods described herein may be implemented by a program storage device readable by machine, tangibly embodying a program of instructions executable by the machine to perform the method steps. It is to be understood that features and elements of the present disclosure may be combined in a plurality of ways, and such combinations are contemplated for embodiments described herein.

Having described preferred embodiments for systems and methods for transferring media rights under predetermined conditions (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the embodiments disclosed herein as outlined by the appended claims. Having thus described the details and particularity required by the patent laws, what is claimed and desired protected by Letters Patent is set forth in the appended claims.

1. A method for distributing media rights, comprising the steps of:
obtaining (102) media rights for distribution by a media rights holder;
transmitting (103) media content to one or more conditional users from the media rights holder; and
upon termination of a condition related to a status of the media rights holder, revoking (112) the media rights of the one or more conditional users.

2. The method as recited in claim 1, wherein the step of transmitting media rights includes downloading (103) media content from a network.

3. The method as recited in claim 1, wherein the step of obtaining (102) media rights includes purchasing media rights from a media rights provider.

4. The method as recited in claim 1, wherein the step of transmitting (103) media content includes broadcasting the media content to conditional users in a given area.

5. The method as recited in claim 1, wherein the step of transmitting (103) media content includes transferring the media content to specifically-identified conditional users.

6. The method as recited in claim 5, wherein the step of transferring is performed by at least one of email, file transfer and instant messaging.

7. The method as recited in claim 1, wherein the step of revoking (112) the media rights of the one or more conditional users includes revoking the media rights when the media rights holder goes off-line.

8. The method as recited in claim 1, wherein the step of revoking (112) the media rights of the one or more conditional users includes revoking the media rights when the media rights holder turns off a device used for transmitting.

9. The method as recited in claim 1, further comprising the step of conditionally using (105) the media content by the one or more conditional users.

10. The method as recited in claim 9, wherein the step of conditionally using (105) includes conditionally using the media content by the one or more conditional users independently of the media rights holders usage of the same media content.

11. The method as recited in claim 1, further comprising the step of offering (114) the media content for sale to the conditional users.

12. The method as recited in claim 1, wherein the step upon termination of a condition related to a status of the media rights holder, revoking (112) the media rights of the one or more conditional users includes periodically sending license updates to the one or more conditional users, and revoking the media rights by failing to send a license update.

13. A program storage device readable by machine, tangibly embodying a program of instructions executable by the machine to perform method steps as recited in claim 1.

14. A method for distributing media rights, comprising the steps of:
transmitting (103) authorized media content from a media rights holder to one or more conditional users;
determining (106) a condition status based upon an activity performed by the media rights holder, wherein the activity is related to equipment status of the media rights holder;
if the condition is valid, permitting (110) the one or more conditional users to continue use of the media content; and
if the condition is not valid, revoking (112) media rights for using of the media content by the one or more conditional users.

15. The method as recited in claim 14, wherein the step of transmitting (103) includes broadcasting the media content to conditional users in a given area.

16. The method as recited in claim 14, wherein the step of transmitting (103) includes transferring the media content to specifically-identified conditional users.

17. The method as recited in claim 16, wherein the step of transferring is performed by at least one of email, file transfer and instant messaging.

18. The method as recited in claim 14, wherein the condition status includes an operational state (107) of a device employed by the media rights holder to perform the step of transmitting.

19. The method as recited in claim 14, wherein the condition status includes a power state (107) for a device of media rights holder, and the condition is valid while the device is on.

20. The method as recited in claim 14, wherein the condition status includes signal power (107), and the condition is valid while the conditional users receive a usable signal from the media rights holder.

21. The method as recited in claim 14, further comprising the step of conditionally using (105) the media content by the one or more conditional users. independently of the media rights holders usage of the same media content.

22. The method as recited in claim 14, wherein the step if the condition is not valid, revoking (112) media rights for using of the media content by the one or more conditional users includes periodically sending license updates to the one or more conditional users, and revoking the media rights by failing to send a license update.

23. A program storage device readable by machine, tangibly embodying a program of instructions executable by the machine to perform method steps as recited in claim 14.

24. A system (100) for distributing media rights, comprising:
a first device (12) configured to communicate with other devices and transmit media rights to other devices for conditional use; and
at least one module (20, 22), which monitors a state upon which a condition of use is based,
wherein the first device (12) permits conditional usage of media content and revokes the media rights when a condition of use fails.

25. The system as recited in claim 24, wherein the state includes a power status of the first device (12) wherein the condition fails when the first device (12) is powered off.

26. The system as recited in claim 24, wherein the state includes a signal strength of the first device (12) wherein the condition fails when the first device (12) is out of range.

27. The system as recited in claim 24, wherein the first device (12) communicates wirelessly with the other devices (14).

28. The system as recited in claim 24, wherein the first device (14) communicates over a network (18) with the other devices (14).

29. The system as recited in claim 24, wherein the state includes a periodically updated license (20) provided to a conditional user (14) and the condition fails when the periodically updated license is not sent to the conditional user.
